(19) United States
(12) Patent Application Publication
(10) Pub. No.: US 2020/0331133 A1
(43) Pub. Date: Oct. 22, 2020

(54) SPARE STAPLE STORAGE DEVICE

(71) Applicant: Robert B. Eisenhauer, III, Melbourne, FL (US)

(72) Inventor: Robert B. Eisenhauer, III, Melbourne, FL (US)

(21) Appl. No.: 16/388,134

(22) Filed: Apr. 18, 2019

(51) Int. Cl. B25C 3/00; B25C 7/00

(52) U.S. Cl. CPC B25C 3/002; B25C 5/1679; B25C 7/00

(57) ABSTRACT

A spare staple storage device including a housing, a retaining mechanism carrier, and a retaining mechanism. The housing having a first end, an opposing second end, and a flat surface adapted to secure to a stapler extending an entirety of a length of the housing between the first end and the second end. The retaining mechanism carrier affixed to the housing. The retaining mechanism carried by the retaining mechanism carrier and adapted to selectively occlude a first opening at the first end of the housing.

### FIELD OF THE INVENTION

The present invention relates to systems for containing spare staple strips. More specifically, the present invention relates to a spare staple storage device, which may be secured to or integrated with a stapler and adapted to contain one or more spare staple strips.

### BACKGROUND OF THE INVENTION

Staplers for stapling together papers or securing sheets to objects are in common use. These devices used in office environments generally include a base portion with an anvil surface, a manually operable pusher arm, and a magazine in the pusher arm that holds a strip of staples and that feeds them against the anvil in a stapling process. In some embodiments of staplers, commonly referred to as staple guns, used to secure paper or other sheets of material to solid object, there is often no base portion and the pusher arm is replaced with a trigger, which is activated by an operator tightening his or her grip on the trigger to advance a staple from the staple strip out of the magazine and into the object against which the mouth of the stapler is positioned. Each time the strip of staples loaded into the stapler is exhausted, it is necessary for the operator to stop the job and obtain a new strip of staples from the supply area for reloading the stapler magazine. Oftentimes the operator does not wish to interrupt the job for any length of time to locate the staple supply are and obtain a new strip for reloading. Sometimes the refill staple strips are stored in a location removed from the location at which the operator is using the stapler. Also, oftentimes the staple supply is entirely exhausted whereby the job must be stopped altogether. Therefore, there exists a need for a device that secures to or is integrated with the stapler and holds spare staple strips, while allowing the stapler to operate conventionally.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a spare staple storage device including a housing, a retaining mechanism carrier, and a retaining mechanism. The housing may have a first end, an opposing second end, and a flat surface adapted to secure to a stapler extending an entirety of a length of the housing between the first end and the second end. The retaining mechanism carrier may be affixed to the housing. The retaining mechanism may be carried by the retaining mechanism carrier and adapted to selectively occlude a first opening at the first end of the housing.

The housing may include a hollow tube, which may be rectangular, round, or square.

The spare staple storage device may further include an elongate occluding member fixedly positioned to occlude a second opening at the second end of the housing.

The retaining mechanism may include an elongate retaining member having a first end and an opposing second end.

The retaining mechanism may further include a spring having a first end secured to a second end of the elongate retaining member and a second end secured to the retaining mechanism carrier.

The spare staple storage device may further include an elongate fastening member fixedly positioned within the retaining mechanism carrier and adapted to secure the spring to the retaining mechanism carrier.

The elongate retaining member may have an aperture in the second end adapted to receive a portion of the spring.

The elongate retaining member may include a threaded rod.

The retaining mechanism may further include a threaded nut carried by the threaded rod.

The spare staple storage device may further include at least one staking dimple located on the retaining mechanism carrier between the threaded nut and the first end of the retaining mechanism carrier.

The elongate retaining member may include a first elongate portion carried within the retaining mechanism carrier and a second elongate portion positioned outside of the retaining mechanism carrier and secured to the first elongate portion to form a ninety-degree angle between the first elongate portion and the second elongate portion.

The retaining mechanism may further include a tube carried by the second elongate portion.

The first end of the housing may have a detent adapted to capture at least a portion of the retaining mechanism.

The spare staple storage device may further include a stapler affixed to the flat surface of the housing.

### BRIEF DESCRIPTION OF THE DRAWINGS

FIG. 1 is an environmental view of a spare staple storage device according to an embodiment of the present invention.

FIG. 2 is a perspective view of the spare staple storage device of FIG. 1,

FIG. 3 is perspective view of the housing of the spare staple storage device of FIG. 1.

FIG. 4 is a top plan view of the housing of the spare staple storage device of FIG. 3.

FIG. 5 is a bottom plan view of the housing of the spare staple storage device of FIG. 3.

FIG. 6 is a first side elevation view of the housing of the spare staple storage device of FIG. 3.

FIG. 7 is a rear elevation view of the housing of the spare staple storage device of FIG. 3.

FIG. 8 is a second side elevation view of the housing of the spare staple storage device of FIG. 3.

FIG. 9 is a perspective view of the retaining mechanism carrier of the spare staple storage device of FIG. 1.

FIG. 10 is a top plan view of the retaining mechanism carrier of FIG. 9.

FIG. 11 is a bottom plan view of the retaining mechanism carrier of FIG. 9.

FIG. 12 is a rear elevation view of the retaining mechanism carrier of FIG. 9.

FIG. 13 is a perspective view of the retaining mechanism of the spare staple storage device of FIG. 1.

FIG. 14 is a bottom plan view of the retaining mechanism of FIG. 12.

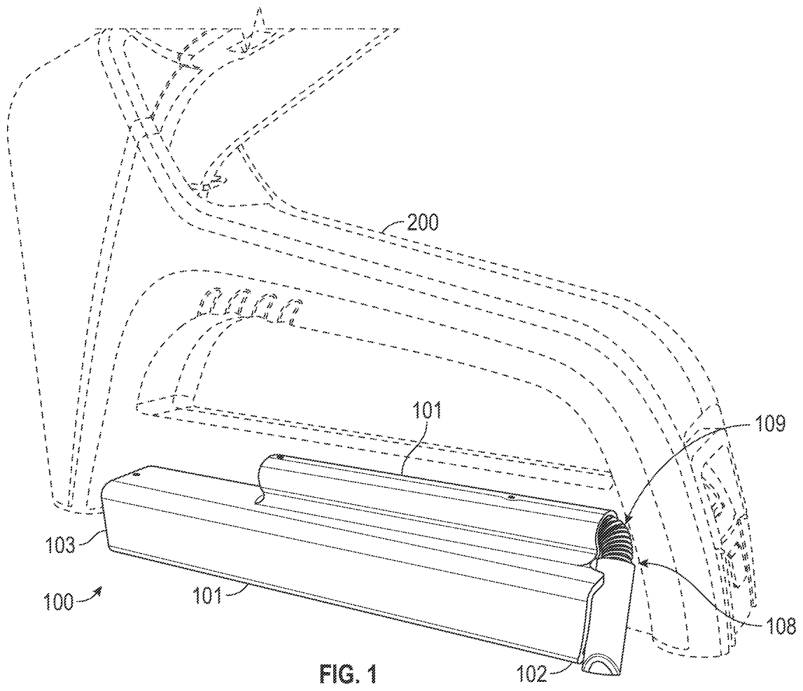

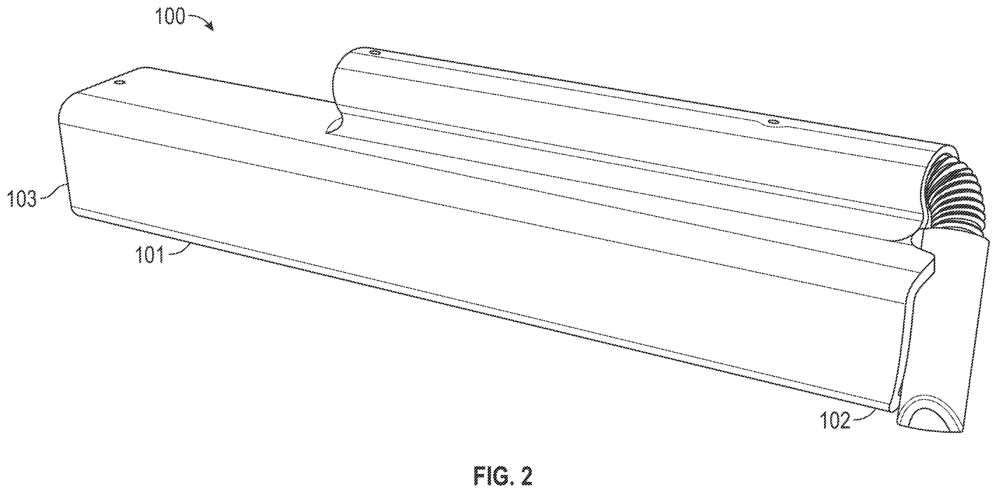

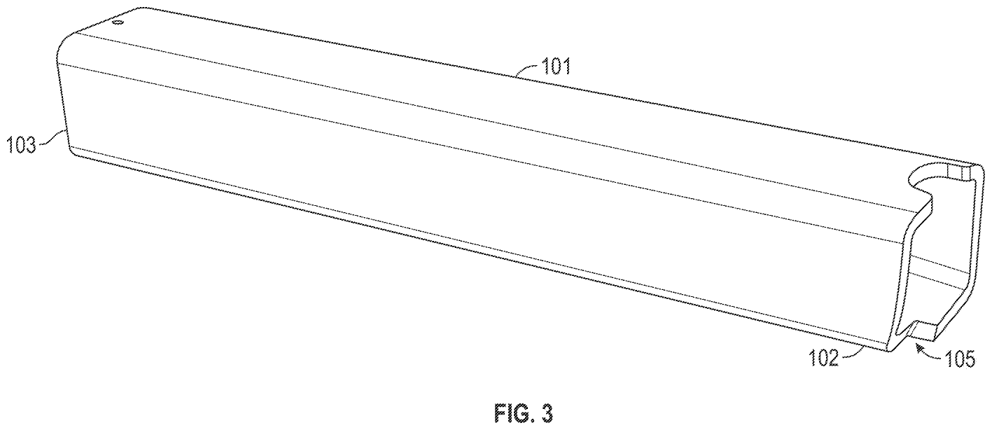

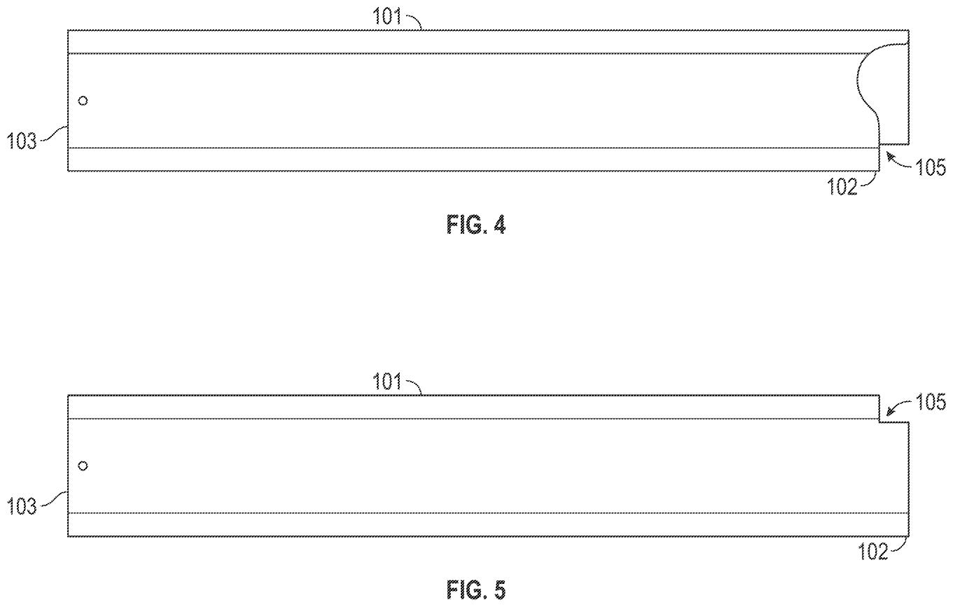

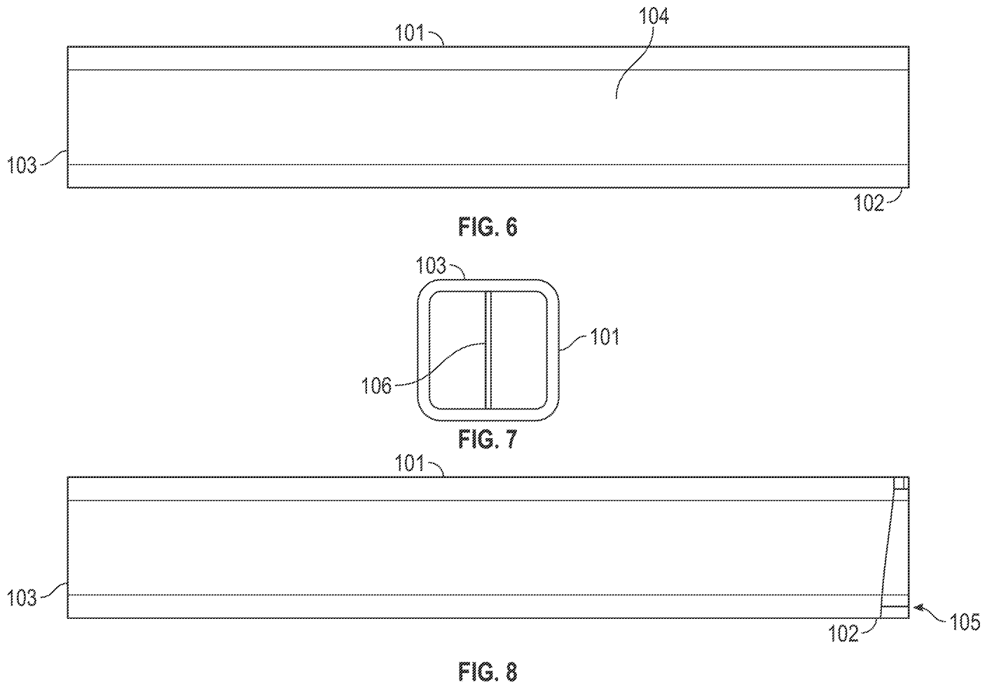

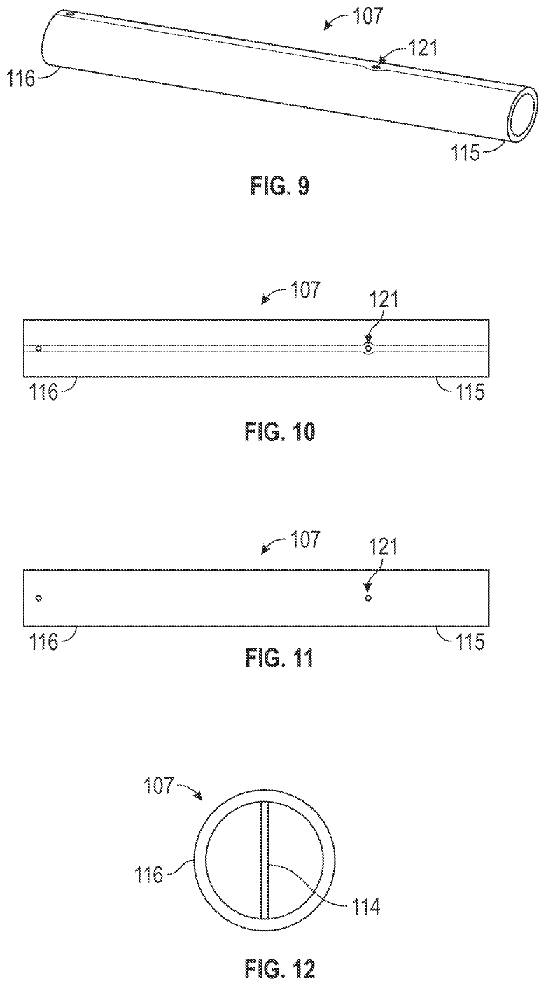

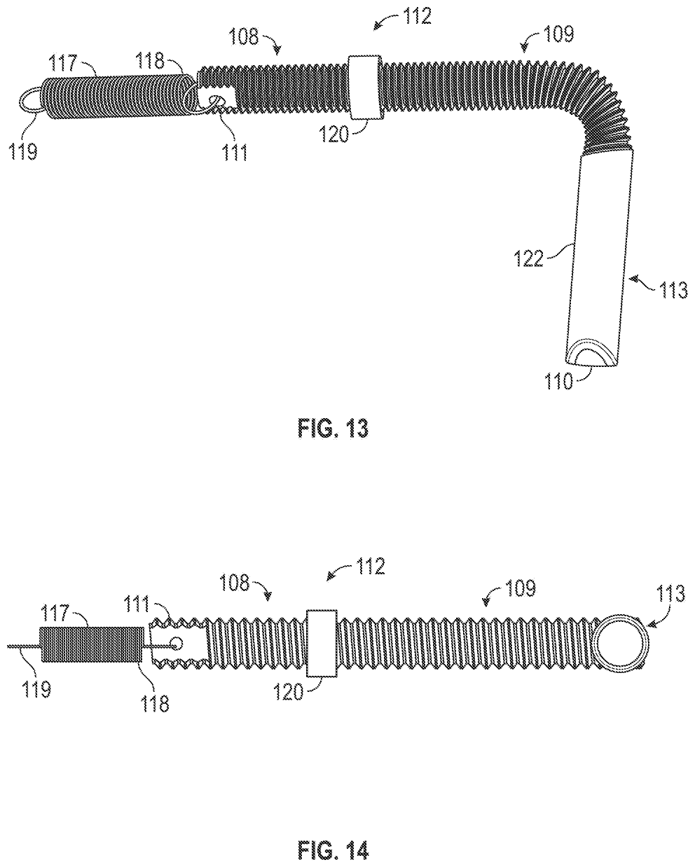

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a spare staple storage device 100. The spare staple storage device 100 may be affixed to a stapler 200 as an after-market accessory or may be integrated into the stapler body. The spare staple storage device 100 may be adapted to carry one or more strips of staples within a housing 101. The spare staple storage device 100 may be especially beneficial for use with staple guns or other staplers, which may be used in locations in which staple stick refills may not be readily available. One or more staple sticks may be placed into the housing 101 of the spare staple storage device 100. The stapler 200 may then be operated as normal. When the operator runs out of staples, the stapler may be conveniently refilled using a spare staple stick carried within the housing 101.

The spare staple storage device 100 may have a housing 101, a retaining mechanism carrier 107, and a retaining mechanism 108, One or more spare staple strips may be carried by the housing 101. The retaining mechanism carrier 107 may be affixed to the housing 101 and carry the retaining mechanism 108, which may be adapted to selectively occlude a first opening of the housing.

The housing 101 may have an interior void sized to carry one or more strips of staples compatible with the stapler to which the spare staple storage device 100 is secured. Inner walls of the housing 101 may define the void within the housing. The void of the housing 101 may have a length slightly greater than a length of a staple strip. The inner void of the housing 101 may have a width slightly greater than a width of a staple strip. The inner void of the housing 101 may have a height greater than a height of a staple strip. In one embodiment, the inner void of the housing 101 may be sized to carry a plurality of staple strips. The housing 101 may be an elongate, hollow member having a first end 102 and an opposing second end 103. The first end 102 the second end 103, or both, may be open. The housing may include a hollow tube. In embodiments in which the housing is a hollow tube, the tube may have a round, rectangular, or square cross-section.

Staple strips may be placed into or removed from the housing 101 through a first opening in the first end 102 of the housing 101. This first opening may be selectively occluded by the retaining mechanism 108, which may be positionable to prevent or allow the one or more staple strips from passing through the first opening. The retaining mechanism 108 may be held in a closed positioned by a detent 105 located in the first end 102 of the housing 101. The retaining mechanism 108 may be moved to an open position by pulling the retaining mechanism 108 away from the housing 101 to remove interference with the detent 105 and rotating the retaining mechanism 108 to a position that does not obstruct the first opening in the first end 102 of the housing.

The detent 105 may be formed in the first end 102 of the housing 101 and adapted to maintain the retaining mechanism 108 in a closed position with an interference fit. The detent 105 may be defined by the profile of the first end 102 of the housing 101. The detent 105 may include a first concave arc on a first side of the upper edge of the first end 102 of the housing 101. The curvature of the first concave arc may mirror the curvature of the portion of the retaining mechanism 108 to be received by the first concave arc when the spare staple storage device 100 is in a closed configuration. The detent 105 may include a second concave arc on a second side of the lower edge of the first end 102 of the housing 101. The curvature of the second concave arc may mirror the curvature of the portion of the retaining mechanism 108 to be received by the second concave arc when the spare staple storage device 100 is in a closed configuration. When positioned in the detent 105, the retaining mechanism 108 may extend from the top to the bottom of the first end 102 of the housing 101 and from a first side to a second side of the first end 102 of the housing 101, The second side of the first end 102 of the housing 101 may be recessed compared to the first side of the first end 102 of the housing 101. Such a recess may make it easier to rotate the retaining mechanism 108 from a closed position to an open position. The second concave arc may be recessed compared to the first concave arc for the same reason.

An elongate occluding member 106 may be positioned across the second end 103 of the housing 101 to occlude a second opening located in the second end 103. There may be a first aperture located on the top of the housing 101 near the second end 103 and a second aperture located on the bottom of the housing 101 opposite the first aperture. In one embodiment, there may be a first aperture located on a first side of the housing 101 near the second end 103 and a second aperture located on a second, opposing side of the housing 101 opposite the first aperture. The elongate occluding member 106 may be carried by and secured within both the first aperture and the second apertures. The elongate occluding member 106 may be secured to the housing 101 with adhesive or welds.

An exterior side of the housing 101 may have a flat surface 104 extending the entirety of the length of the housing 101 between the first end 102 and the second end 103. The flat surface 104 may have a width and length smaller than or equal to a surface on the stapler 200, to which the spare staple storage device 100 may be secured with adhesive, welds, fasteners, or the like. The spare staple storage device 100 may be permanently or removably secured to the stapler at the flat surface 104 and corresponding surface of the stapler 200. In one embodiment, the spare staple storage device 100 may be integrally formed with the stapler 200 and not secured thereto along a flat surface. In such an embodiment, the housing 101 may be integrated into the structure of the stapler 200.

The retaining mechanism carrier 107 may be an elongate, hollow tube adapted to carry at least a portion of the retaining mechanism 108. The retaining mechanism carrier 107 may have an open first end 115 and an opposing, open second end 116. The retaining mechanism carrier 107 may include a first aperture on a top surface and a second aperture located on an opposing bottom surface, aligned with the first aperture and between the first end 115 and second end 116. In one embodiment, the first aperture may be on a side surface and the second aperture may be on an opposing side surface, aligned with the first aperture and between the first end 115 and second end 116. An elongate fastening member 114 may be carried by and extend between the first and second apertures of the retaining mechanism carrier 107. The elongate fastening member 114 may be secured within the apertures by adhesive or welds. The elongate fastening member 114 may occlude the second end of the retaining mechanism carrier 116 and provide structure to which the elongate retaining member 109 may be secured.

The retaining mechanism carrier 107 may have at least one staking dimple 121 formed in a sidewall. The staking dimple 121 may be adapted to contact a nut 120 carried by the elongate retaining member 109 carried within the retaining mechanism carrier 107 and prevent the second end 111 of the elongate retaining member 109 from exiting the retaining mechanism carrier 107. The staking dimple 121 may be positioned on a wall of the retaining mechanism carrier 107 between the nut 120 and the first end 115 of the retaining mechanism carrier 107.

The retaining mechanism 108 may include an elongate retaining member 109 having a first end 110 and an opposing second end 111. The elongate retaining member 109 may be carried partially within and partially outside of the retaining mechanism carrier 107. There may be a first elongate portion 112 of the elongate retaining member 109, which may include the second end 111 of the first elongate portion 112 and may be carried substantially inside of the retaining mechanism carrier 107. There may also be a second elongate portion 113 of the elongate retaining member 109, which may include the first end 110 of the first elongate portion 112 and may not enter the retaining mechanism carrier 107. The first elongate portion 112 and the second elongate portion 113 may be components of a monolithic structure. There may be a ninety-degree bend between the first elongate portion 112 and the second elongate portion 113. Both the first elongate portion 112 and the second elongate portion 113 may be different areas on a single threaded rod forming the elongate retaining member 109.

The elongate retaining member 109 may be a rod, tube, or the like. The elongate retaining member 109 may include a threaded rod, tube, or the like. The second end 111 of the elongate retaining member 109 may have an aperture located therein. The aperture of the elongate retaining member 109 may be adapted to receive a spring 117 coil and secure the spring 117 thereto. The second end 111 of the elongate retaining member 109 may include a protuberance formed in the elongate structure. The protuberance may be formed by removing an upper and lower curved portion of the elongate structure. The outer curved surface may be removed to form the protuberance, which may have a flat lower and opposing flat upper surface extending at the second end 111 of the elongate retaining member 109. The aperture of the elongate retaining member 109 may be formed through an entirety of this protuberance.

The retaining mechanism may include a tube 122 carried by the second elongate portion 113. The tube 122 may cover a portion of the second elongate portion 113, which may include the first end 110 of the elongate retaining member 109. The tube 122 may include an outer surface which is comfortable to be gripped by a user and may contact the detent 105 formed in the first end 102 of the housing 101. The tube 122 may have a closed end located proximate the first end 110 of the elongate retaining member 109. The tube 122 may have an open end distal the closed end of the tube 122. The tube 22 may have an inner diameter slightly greater than or equal to the outer diameter of the elongate retaining member 109. The tube 122 may be secured to the elongate retaining member 109 with adhesive or welds. The elongate retaining member 109 with or without a tube 122 may be received by the detent 105 when the spare staple storage device 100 is in a closed configuration.

In embodiments in which the elongate retaining member 109 includes a threaded rod, tube, or the like, a nut 120 may be carried by the threads of the elongate retaining member 109. The nut 120 may have threads cooperatively configured to mate with the threads of the elongate retaining member 109. The nut 120 may be positionable along a length of the first elongate portion 112 of the elongate retaining member 110. The nut 120 may be positioned on the elongate retaining member 110 between the staking dimple 121 located on the retaining mechanism carrier 107 and the second end 111 of the elongate retaining member 109. The nut 120 may be sized to contact the staking dimple 121 when the first end 110 of the elongate retaining member 109 is pulled in a direction away from the retaining mechanism carrier 107, drawing the nut 120 toward the staking dimple 121. The nut 120 may contact the staking dimple 121 as the elongate retaining member 109 is pulled by the first end 110, thereby preventing the elongate retaining member 109 from being pulled out of the retaining mechanism carrier 107 and also preventing a spring 117 securing the retaining mechanism carrier 107 to the elongate retaining member 109 from hyperextending or deforming.

The retaining mechanism 108 may also include a spring 117. A first end 118 of the spring 117 may be secured to a second end 111 of the elongate retaining member 111. More specifically, a coil on the first end 118 of the spring 117 may encircle an aperture on the second end 111 of the elongate retaining member 109. A second end 119 of the spring 117 may be secured to the retaining mechanism carrier 107, More specifically, a coil on the second end 119 of the spring may encircle the elongate fastening member 114.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof, Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

Thus, the scope of the invention should be determined by the appended claims and theft legal equivalents, and not by the examples given.

That which is claimed is:

1. A spare staple storage device comprising:
a housing having a first end, an opposing second end, and adapted to secure to a stapler;
a retaining mechanism carrier affixed to the housing; and
a retaining mechanism carried by the retaining mechanism carrier and adapted to selectively occlude a first opening at the first end of the housing.

2. The spare staple storage device of claim 1 wherein the housing comprises a hollow tube.

3. The spare staple storage device of claim 1 wherein the housing comprises a rectangular tube.

4. The spare staple storage device of claim 1 wherein the housing comprises a round tube.

5. The spare staple storage device of claim 1 further comprising:
an elongate occluding member fixedly positioned to occlude a second opening at the second end of the housing.

6. The spare staple storage device according to claim 1 wherein the retaining mechanism comprises:
an elongate retaining member having a first end and an opposing second end.

7. The spare staple storage device according to claim 6 wherein the retaining mechanism further comprises:
a spring having a first end secured to a second end of the elongate retaining member and a second end secured to the retaining mechanism carrier.

8. The spare staple storage device according to claim 7 further comprising:
an elongate fastening member fixedly positioned within the retaining mechanism carrier and adapted to secure the spring to the retaining mechanism carrier.

9. The spare staple storage device according to claim 7 wherein the elongate retaining member has an aperture in the second end adapted to receive a portion of the spring.

10. The spare staple storage device according to claim 6 wherein the elongate retaining member comprises a threaded rod.

11. The spare staple storage device according to claim 10 wherein the retaining mechanism further comprises:
a threaded nut carried by the threaded rod.

12. The spare staple storage device according to claim 11 further comprising:
at least one staking dimple located on the retaining mechanism carrier between the threaded nut and the first end of the retaining mechanism carrier.

13. The spare staple storage device according to claim 6 wherein the elongate retaining member comprises:
a first elongate portion carried within the retaining mechanism carrier; and
a second elongate portion positioned outside of the retaining mechanism carrier and secured to the first elongate portion to form a ninety-degree angle between the first elongate portion and the second elongate portion.

14. The spare staple storage device according to claim 13 wherein the retaining mechanism further comprises a tube carried by the second elongate portion.

15. The spare staple storage device according to claim 1 wherein the first end of the housing has a detent adapted to capture at least a portion of the retaining mechanism.

16. The spare staple storage device according to claim 1 further comprising:
a stapler affixed to the flat surface of the housing.

17. A spare staple storage device comprising:
a housing comprising:
a first hollow tube having a first end, an opposing second end, and a flat surface adapted to secure to a stapler extending an entirety of a length of the first hollow tube between the first end and the second end;
a retaining mechanism carrier affixed to the housing and comprising:
a second hollow tube;
a retaining mechanism comprising:
a threaded rod having a first elongate portion carried within the second hollow tube of the retaining mechanism carrier and a second elongate portion positioned outside of the second hollow tube of the retaining mechanism carrier with a ninety-degree angle formed between the first elongate portion and the second elongate portion; and
wherein the second elongate portion is adapted to selectively occlude a first opening at the first end of the first hollow tube.

18. The spare staple storage device according to claim 17 wherein the retaining mechanism further comprises:
a spring having a first end secured to a second end of the first elongate portion of the threaded rod and a second end secured to the second hollow tube.

19. The spare staple storage device according to claim 17 further comprising:
at least one staking dimple located on the second hollow tube between the threaded nut and the first end of the hollow tube; and
wherein the retaining mechanism further comprises:
a threaded nut carried by the first elongate portion of the threaded rod.

20. A spare staple storage device comprising:
a housing comprising:
a hollow, square tube having a first end, an opposing second end, and a flat surface adapted to secure to a stapler extending an entirety of a length of the hollow, square tube between the first end and the second end;
a retaining mechanism carrier affixed to the hollow, square tube;
a retaining mechanism comprising:
a threaded elongate retaining member having a first elongate portion carried by the retaining mechanism carrier and a second elongate portion positioned outside of the retaining mechanism carrier and secured to the first elongate portion to form a ninety-degree angle between the first elongate portion and the second elongate portion,
an aperture formed in the first elongate portion of the threaded elongate retaining member,
a tube carried by the second elongate portion of the threaded elongate retaining member,
a spring having a first end captured by the aperture of the first elongate portion of the threaded elongate retaining member,
an elongate fastening fixedly positioned to capture the spring and secure a second end of the spring to the retaining mechanism carrier,
a threaded nut carried by the threaded rod,
at least one staking dimple located on the retaining mechanism carrier between the threaded nut and the first end of the retaining mechanism carrier, and
wherein the second elongate portion is adapted to selectively occlude a first opening at the first end of the hollow, square tube;
an elongate occluding member fixedly positioned to occlude a second opening at the second end of the hollow, square tube;
wherein the first end of the hollow, square tube has a detent adapted to capture at least a portion of the retaining mechanism; and
wherein the flat surface of the hollow, square tube is adapted to secure to a stapler.
